(19) United States
(12) Patent Application Publication
(10) Pub. No.: US 2008/0272326 A1
(43) Pub. Date: Nov. 6, 2008

(54) Driving tool and head valve assembly for a driving tool

(76) Inventor: William C. Buck, Clemson, SC (US)

Correspondence Address: TTi/BRINKS HOFER GILSON & LIONE, P.O.BOX 10395, CHICAGO, IL, 60610, US

(21) Appl. No.: 11/799,501

(22) Filed: May 2, 2007

(51) Int. Cl. F16K 1/32; B27F 7/09

(52) U.S. Cl. 251/320; 227/130

(57) ABSTRACT

A driving tool and a head valve assembly for a driving tool. The head valve assembly may include an end cap, a seal bushing received within the end cap, a movable member slidably movable with respect to the seal bushing between a first position and a second position, and a flexible membrane configured to bias the movable member towards the first position. The seal bushing cooperates with the end cap to define a first cavity and a vent path fluidly connected to the first cavity. The vent path is substantially unobstructed when the movable member is in the first position, and the vent path is sealed by a sealing portion of the movable member when the movable member is in the second position.

The present invention relates to a driving tool and a head valve assembly for a driving tool. More specifically, the present invention relates to a head valve assembly for a pneumatically-operated device for driving fasteners.

### BACKGROUND OF THE INVENTION

Pneumatically-operated driving tools are typically used to drive fasteners into a working surface, such as wood or metal. These tools typically include a nosepiece for holding a fastener, a driving assembly for driving the fastener from the nosepiece, a compressed air supply, and a head valve assembly for selectively connecting the compressed air supply to the driving assembly and actuating the driving assembly. However, currently-known head valve assemblies include a relatively high number of components and may be overly-complex, thereby potentially increasing assembly and/or part costs and potentially reducing the effective life of the driving tool.

### BRIEF SUMMARY OF THE INVENTION

In one aspect, the present invention includes a head valve assembly for a driving tool, such as a pneumatically-operated device for driving fasteners. The head valve assembly may include an end cap, a seal bushing received within the end cap, a movable member slidably movable with respect to the seal bushing between a first position and a second position, and a flexible membrane configured to bias the movable member towards the first position. The seal bushing cooperates with the end cap to define a first cavity and a vent path fluidly connected to the first cavity. The vent path is substantially unobstructed when the movable member is in the first position, and the vent path is sealed by a sealing portion of the movable member when the movable member is in the second position.

In one aspect, the flexible membrane does not engage the seal bushing when the movable member is in the first position or when the movable member is in the second position. In another aspect, the flexible membrane does not engage the seal bushing during normal operation of the head valve assembly. The flexible membrane may include a first annular rim embedded within an annular channel of the end cap and an annular groove receiving an annular rim of the movable member.

In another aspect, the present invention includes a pneumatic driving tool. The pneumatic driving tool may include a housing defining a compressed air chamber, a nosepiece having a firing chamber configured to receive a fastener, a driving assembly received within the housing and for driving the fastener from the nosepiece, and a head valve assembly for selectively fluidly connecting the compressed air chamber with the driving assembly to actuate the driving assembly.

The driving assembly may include a cylinder and a piston slidably disposed within the cylinder for driving the fastener from the nosepiece. The flexible membrane may include a lower sealing surface for selectively engaging a top rim of the cylinder and fluidly separating the driving assembly from the compressed air chamber when the movable member is in the first position.

Further objects, features and advantages of the invention will become readily apparent to persons skilled in the art after a review of the following description, with reference to the drawings and claims that are appended to and form a part of this specification.

### BRIEF DESCRIPTION OF THE DRAWINGS

FIG. 1 is an isometric view of a driving tool embodying the principles of the present invention;

FIG. 2 is cross-sectional view taken along line 2-2 in FIG. 1, showing a head valve assembly with the movable member in a first position;

FIG. 3 is cross-sectional view similar to that shown in FIG. 2, where the movable member in a second position.

### DETAILED DESCRIPTION OF THE INVENTION

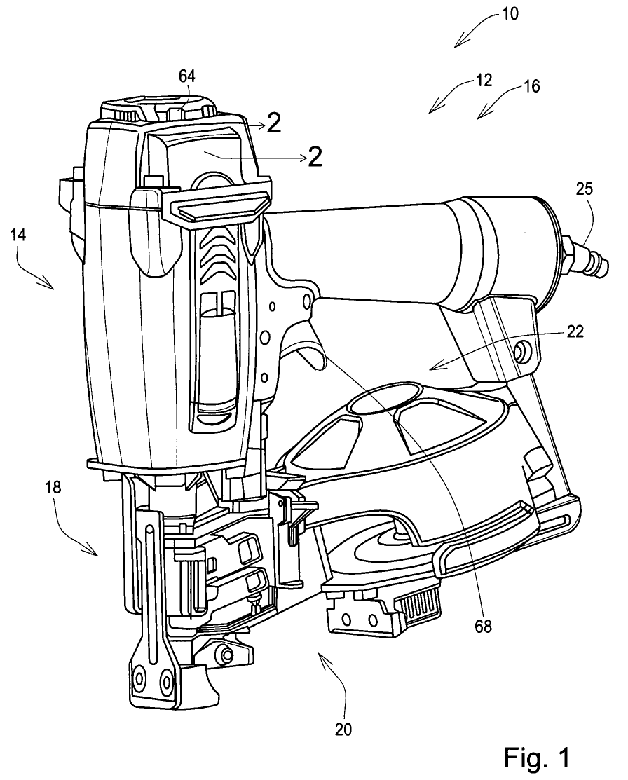

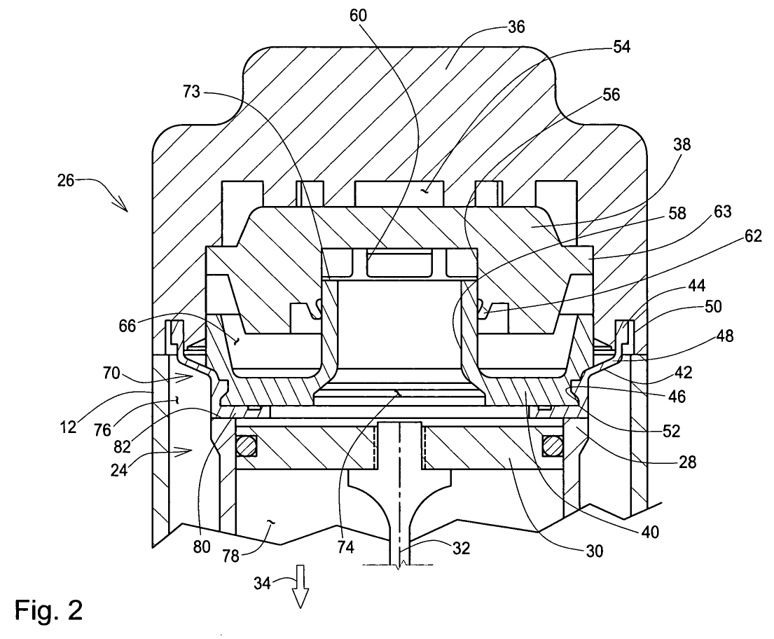

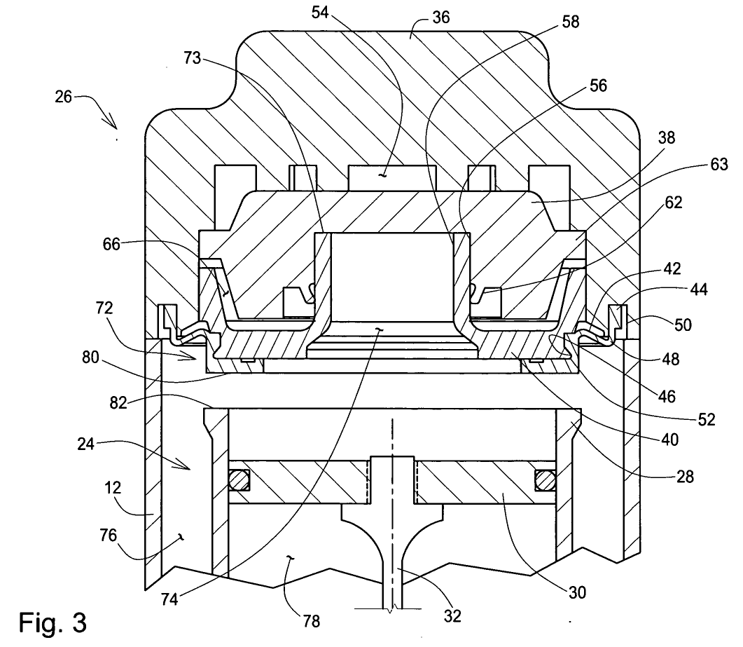

Referring now to the drawings and initially to FIG. 1, a driving tool, such as a nailer 10, is shown. The nailer 10 includes a housing 12 having a body 14 and a handle 16, a nosepiece 18 for receiving a fastener to be driven from the nailer 10, a nail supply assembly 20 for supplying fasteners to the nosepiece 18, a fastener magazine 22 for storing the fasteners, a driving assembly 24 (FIGS. 2 and 3) for driving the fastener from the nosepiece 18, and a head valve assembly 26 (FIGS. 2 and 3) for controlling actuation of the driving assembly 24. The handle 16 is connected to a pressurized air supply via an inlet fitting 25 for supplying compressed air to the driving assembly 24. More specifically, the handle 16 includes an inlet conduit extending towards an upper portion of the body 14, where the head valve assembly 26 controls the actuation of the driving assembly 24.

Referring to FIGS. 2 and 3, the driving assembly 24 typically includes a cylinder 28, a piston 30 movable within the cylinder 28, and a driving rod 32 attached to the piston 30 for contacting the fastener when the piston 30 is actuated in a downward direction (as indicated by arrow 34 in FIG. 2). The head valve assembly 26 controls the actuation of the piston 30 by selectively connecting the pressurized air supply to the top side of the piston 30.

The head valve assembly 26 includes an end cap 36 positioned at the top portion of the housing 12, a seal bushing 38 positioned within the end cap 36, a movable member 40 positioned within the end cap 36 and movable with respect to the end cap 36 and the seal bushing 38, and a flexible membrane 42 having a first portion engaging the end cap 36, a second portion engaging the movable member 40, and a flexible portion 48 extending therebetween. The first portion is a first annular rim 44 embedded within an annular channel 50 and the second portion is an annular groove 46 configured to receive an annular rim 52 of the movable member 40. More specifically, the annular rim 52 of the flexible membrane 42 is snap-fit into the annular groove 46 so the movable member 40 and the first portion of the flexible membrane 42 move in unison with each other. The first annular rim 44 remains within the annular channel 50 due to the shape memory of the flexible membrane 42 and the pressure from the air supply, as will be discussed in more detail below.

The end cap 36 defines the top portion of the nailer 10 and is generally aligned with the cylinder 28. The seal bushing 38 is a generally disk-shaped component fixedly connected to the end cap 36 and cooperating therewith to define an exhaust cavity 54. The seal bushing 38 includes a cylindrical-shaped receiving portion 56 for receiving a cylindrical portion 58 of the movable member 40 and a plurality of seal bushing openings 60 that define a venting path, as discussed in more detail below. The seal bushing 38 also includes an annular seal 62 at the lower boundary of the receiving portion 56 for forming a generally fluid-tight seal with the movable member 40, as is also discussed in more detail below. The seal bushing 38 also includes an annular outer sealing ring 63 that engages an inner wall of the end cap in an interference fit to form a fluid-tight seal between the seal bushing 38 and the end cap 36. The top of the end cap 36 includes a plurality of exhaust openings 64 (FIG. 1) that fluidly connect the exhaust cavity 54 to the ambient air.

As mentioned above, the movable member 40 includes the cylindrical portion 58 that has a size and shape to fit within the receiving portion 56 of the seal bushing 38 and to define a seal therewith. More specifically, the cylindrical portion 58 of the movable member 40 forms the fluid-tight seal with the annular seal 62 of the seal bushing 38 to define an upper pressurized cavity 66 that is fluidly separated from the exhaust cavity 54. The upper pressurized cavity 66 is selectively pressurized by the pressurized air supply and depressurized by an exhaust valve connected to a nailer trigger 68 (FIG. 1), as discussed in further detail below.

The movable member 40 is slidably movable between a first position 70 (FIG. 2), where the vent path defined by the openings 60 in the seal bushing 38 are substantially unobstructed, and a second position 72 (FIG. 3), where the vent path defined by the openings 60 in the seal bushing 38 is sealed by an end face 73 of the cylindrical portion 58 of the movable member 40. Therefore, when the movable member 40 is in the first position 70, the exhaust cavity 54 is fluidly connected with the space 74 between the piston 30 and the movable member 40, and when the movable member 40 is in the second position 72, the exhaust cavity 54 is sealed from the space 74 between the piston 30 and the movable member 40. As mentioned above, the exhaust cavity 54 is always fluidly connected with ambient air via the exhaust openings 64 (FIG. 1).

The cylinder 28 and the underside of the piston 30 cooperate to define a piston cavity 78. Additionally, the driving assembly 24 cooperates with the head valve assembly 26 to define a lower pressurized cavity 76 on the opposite side of the movable member 40 from the upper pressurized cavity 66. Like the upper pressurized cavity 66, the lower pressurized cavity 76 is pressurized by the air supply. However, unlike the upper pressurized cavity 66, the lower pressurized cavity 76 is not fluidly connected to the exhaust valve controlled by the trigger 68.

When the pressurized air supply is connected to the nailer 10 and the trigger 68 is in its natural, non-actuated state, the upper and lower pressurized cavities 66, 76 are both pressurized by the air supply. Additionally, in this state, the movable member 40 is in the first position 70 (FIG. 2) because the net force created by the upper pressurized cavity 66 is greater than that created by the lower pressurized cavity 76. More specifically, although the pressure in the upper pressurized cavity 66 is equal to the pressure in the lower pressurized cavity 76, the upper pressurized cavity 66 has a larger surface area than the lower pressurized cavity 76 so that the movable member 40 is urged into the first position 70. When the movable member 40 is in the first position 70, a sealing portion 80 of flexible membrane 42 engages a top rim 82 of the cylinder 28, thereby forming a generally fluid-tight seal between the respective components.

When the pressurized air supply is not connected to the nailer 10, neither of the upper and lower pressurized cavities 66, 76 are pressurized and therefore neither of the cavities 66, 76 exert any forces on the movable member 40. However, the flexible membrane 62 is configured to bias the movable member 40 towards the first position 70 such that the movable member 40 remains in the first position 70. For example, the flexible membrane 62 has shape memory for its natural position shown in FIG. 2.

During operation of the nailer 10, the respective air pressures of the four cavities 54, 66, 76, 78 determine the position of the movable member 40 and the piston 30. First, as shown in FIG. 2, when the net force created by the upper pressurized cavity 66 is greater than that created by the lower pressurized cavity 76, the movable member 40 is in the first position 70 and the piston 30 is positioned at or near the top of the cylinder 28.

Next, as shown in FIG. 3, when the pressure in the upper pressurized cavity 66 is reduced by actuating the trigger 68 and purging the air from the upper pressurized cavity 66, the movable member 40 is urged upward to unseat the flexible membrane 42 from the top of the cylinder 28. More specifically, because the upper pressurized cavity 66 is fluidly connected to the ambient air and the lower pressurized cavity 76 remains pressurized by the air supply, the movable member 40 is urged upward. When the end face 73 of the cylindrical portion 58 of the movable member 40 engages the top wall of the seal bushing 38, the exhaust cavity 54 becomes sealed from the space 74 and the air pressure in the lower pressurized cavity 76 forces the piston 30 downward within the cylinder 28, thereby driving the fastener from the nosepiece 18 (FIG. 1). During the piston downstroke, a piston return chamber (not shown) connected to the piston cavity 78 becomes pressurized.

Finally, the trigger valve is closed and the upper pressurized cavity 66 is repressurized by the pressurized air source. The force from the air pressure combined with the force from the flexible membrane 42 causes the movable member 40 to move back into the first position 70. The pressure differential between the piston return chamber and the exhaust cavity 54 then causes the piston to move upward into the top dead center position shown in FIG. 2.

As discussed above, the exhaust cavity 54 is always fluidly connected with ambient air and the upper pressurized cavity 66 is likewise connected with ambient air when the trigger 68 is depressed. Therefore, when the movable member 38 is traveling upward, no pressurized cavities resist the upwardly acting forces of the lower pressurized cavity 76. As a result of this configuration, the friction between the movable member cylindrical portion 58 and the seal bushing annular seal 62 is relatively low. Therefore, part wear is potentially reduced and the head valve assembly 26 may be able to operate without any added lubricants such as oil between the respective components 58, 62.

The flexible membrane 42 does not engage the seal bushing 38 when the movable member 40 is in the first position 70, the second position 72, or any other position during normal operation of the nailer. For example, the term “normal operation” is defined as the state when the nailer 10 is assembled (as shown in the Figures) and able to drive fasteners into a working surface. Because the flexible membrane 42 is not subject to forces that urge the flexible membrane 42 to become disconnected from the movable member 40, part wear is potentially reduced and the effective life of the nailer is potentially increased.

While the invention has been described in conjunction with specific embodiments it is to be understood that many alternatives, modifications, and variations will be apparent to those skilled in the art in light of the foregoing detailed description. It is therefore intended that the foregoing description be regarded as illustrative rather than limiting, and that it be understood that it is the following claims, including all equivalents, that are intended to define the spirit and scope of this invention.

What is claimed:

1. A head valve assembly for a driving tool comprising:
an end cap;
a seal bushing at least partially received within the end cap and cooperating therewith to define a first cavity, the seal bushing at least partially defining a vent path fluidly connected to the first cavity;
a movable member at least partially received within the end cap and slidably movable with respect to the seal bushing between a first position where the vent path is substantially unobstructed and a second position where the vent path is sealed by a sealing portion of the movable member; and
a flexible membrane engaging the movable member and configured to bias the movable member towards the first position.

2. A head valve assembly as in claim 1, wherein the flexible membrane does not engage the seal bushing when the movable member is in the first position or when the movable member is in the second position.

3. A head valve assembly as in claim 2, wherein the flexible membrane does not engage the seal bushing during normal operation of the head valve assembly.

4. A head valve assembly as in claim 1, wherein the flexible membrane includes a first portion engaging the end cap, a second portion engaging the movable member, and a flexible portion extending therebetween.

5. A head valve assembly as in claim 4, wherein the first portion of the flexible membrane is a first annular rim embedded within an annular channel of the end cap and the second portion of the flexible membrane is an annular groove configured to receive an annular rim of the movable member.

6. A head valve assembly as in claim 1, wherein the seal bushing includes a plurality of openings extending therethrough and defining the vent path.

7. A head valve assembly as in claim 6, wherein the movable member includes a generally cylindrical portion configured to engage an annular inner wall of the seal bushing and seal the vent path when the movable member is in the second position.

8. A pneumatic driving tool comprising:
a housing defining a compressed air chamber;
a nosepiece coupled with the housing and having a firing chamber configured to receive a fastener;
a driving assembly at least partially received within the housing and configured to drive the fastener from the nosepiece; and
a head valve assembly for selectively fluidly connecting the compressed air chamber with the driving assembly, the head valve assembly including:
an end cap;
a seal bushing at least partially received within the end cap and cooperating therewith to define a first cavity, the seal bushing at least partially defining a vent path fluidly connected to the first cavity;
a movable member at least partially received within the end cap and slidably movable with respect to the seal bushing between a first position where the vent path is substantially unobstructed and a second position where the vent path is sealed by a sealing portion of the movable member; and
a flexible membrane engaging the movable member and configured to bias the movable member towards the first position.

9. A pneumatic driving tool as in claim 8, wherein the flexible membrane does not engage the seal bushing when the movable member is in the first position or when the movable member is in the second position.

10. A pneumatic driving tool as in claim 9, wherein the flexible membrane does not engage the seal bushing during normal operation of the pneumatic driving tool.

11. A pneumatic driving tool as in claim 8, wherein the flexible membrane includes a first portion engaging the end cap, a second portion engaging the movable member, and a flexible portion extending therebetween.

12. A pneumatic driving tool as in claim 11, wherein the first portion of the flexible membrane is a first annular rim embedded within an annular channel of the end cap and the second portion of the flexible membrane is an annular groove configured to receive an annular rim of the movable member.

13. A pneumatic driving tool as in claim 12, wherein the flexible membrane further includes a lower sealing surface configured to selectively engage a portion of the driving assembly and fluidly separate the driving assembly from the compressed air chamber when the movable member is in the first position.

14. A pneumatic driving tool as in claim 13, wherein the driving assembly includes a cylinder and a piston slidably disposed within the cylinder for driving the fastener from the nosepiece, and wherein the lower sealing surface of the flexible membrane is configured to selectively engage a top rim of the cylinder and fluidly separate the driving assembly from the compressed air chamber when the movable member is in the first position.

15. A pneumatic driving tool as in claim 8, wherein the seal bushing includes a plurality of openings extending therethrough and defining the vent path.

16. A pneumatic driving tool as in claim 15, wherein the movable member includes a generally cylindrical portion configured to engage an annular inner wall of the seal bushing and seal the vent path when the movable member is in the second position.

17. A pneumatic driving tool comprising:
a housing defining a compressed air chamber;
a nosepiece coupled with the housing and having a firing chamber configured to receive a fastener;
an end cap coupled with the housing;
a seal bushing at least partially received within the end cap and cooperating therewith to define a venting cavity, the seal bushing at least partially defining a vent path fluidly connected to the venting cavity;
a movable member at least partially received within the end cap and slidably movable with respect to the seal bushing between a first position where the vent path is substantially unobstructed and a second position where the vent path is sealed by a sealing portion of the movable member; and
a flexible membrane engaging the movable member and configured to bias the movable member towards the first position, the flexible membrane including a lower sealing surface configured to selectively engage a top rim of the cylinder and fluidly separate the driving assembly from the compressed air chamber when the movable member is in the first position.

18. A pneumatic driving tool as in claim 17, wherein the flexible membrane does not engage the seal bushing when the movable member is in the first position or when the movable member is in the second position.

19. A pneumatic driving tool as in claim 18, wherein the flexible membrane does not engage the seal bushing during normal operation of the pneumatic driving tool.

20. A pneumatic driving tool as in claim 17, wherein the flexible membrane further includes a first annular rim embedded within an annular channel of the end cap, an annular groove configured to receive an annular rim of the movable member, and a flexible portion extending therebetween.
